(19) United States
(12) Patent Application Publication
(10) Pub. No.: US 2022/0098902 A1
(43) Pub. Date: Mar. 31, 2022

(54) SECURE STORAGE BOX

(71) Applicant: ASSA ABLOY Residential Group, Inc., New Haven, CT (US)

(72) Inventor: Wai P. Wong, Orange, CT (US)

(73) Assignee: ASSA ABLOY Residential Group, Inc., New Haven, CT (US)

(21) Appl. No.: 17/479,606

(22) Filed: Sep. 20, 2021

Related U.S. Application Data
(60) Provisional application No. 63/086,007, filed on Sep. 30, 2020.

(51) Int. Cl. E05B 65/00; E05G 1/04; E05G 1/00; E05B 65/52

(52) U.S. Cl. CPC E05B 65/0075; E05B 65/5253; E05G 1/005; E05G 1/04

(57) ABSTRACT

Embodiments disclosed herein relate to secure storage boxes having a lock post bracket attached to a lid of the secure storage box and a lock body bracket attached to a body portion of the secure storage box. The lost post bracket may be constructed to retain a lock post, and the lock body bracket may be constructed to retain a lock body. The lock body may include an opening configured to selectively retain the lock post when the lid of the secure storage box is closed. Thus, the lock body may prevent the lid of the secure storage box from opening by retaining the lock post. Moreover, the lock post bracket and the lock body bracket may include features for confirming the alignment of the lock post to the opening in the lock body. For example, the lock post bracket may include two or more hollow cylinders configured to register with two or more complementary pins disposed on the lock body bracket. Moreover, the lock body and lock body bracket may a complementary interface for confirming that a compatible lock body has been installed with the lock body bracket.

### CROSS-REFERENCE TO RELATED APPLICATIONS

This application claims the benefit under 35 U.S.C. § 119(e) of U.S. Provisional Application Ser. No. 63/086,007, titled “SECURE STORAGE BOX,” filed on Sep. 30, 2020, which is incorporated herein in its entirety.

### FIELD

Disclosed embodiments relate to secure storage boxes, for example, a secure storage box having a locking mechanism mounted therein.

### BACKGROUND

Concerns associated with unattended parcel delivery include overall security of delivery upon drop-off, validation of delivery and/or receipt of the parcel, and alternatives to signature confirmation. Because the delivery carrier is often not aware of the presence (or absence) of an intended recipient of a parcel, shipments that require delivery and/or signature confirmation often go unfilled. Multiple attempts at such deliveries can result in a waste of time and fuel by the carrier, and potential loss of opportunity for further e-retail revenue. Shipments that do not require delivery and/or signature confirmation are susceptible to theft. Thus, parcel recipients, delivery carriers, and/or e-retailers may employ one or more secure locations, such as delivery to a predetermined location, allowing the delivery carrier to deliver the parcel when convenient for the delivery carrier, while allowing the intended recipient of the parcel to retrieve the parcel when convenient for the intended recipient.

### BRIEF SUMMARY

The Inventors have invented a secure storage box having a locking mechanism mounted therein.

In some embodiments, a secure storage box includes a post bracket, a lock body bracket, two or more alignment pins disposed on the lock body bracket, and two or more hollow cylinders disposed on the post bracket. The two or more alignment pins and the two or more hollow cylinders may be positioned such that the two or more hollow cylinders fit over the two or more alignment pins.

In some embodiments, a bracket for receiving a lock body includes an opening configured to receive the lock body and a T-slot configured to retain the lock body within the opening. The lock body may include a T-fastener complementary to the T-slot, and the T-slot may be configured prevent the lock body from moving in at least a first direction when the T-fastener is inserted into the T-slot.

In some embodiments a combination of a bracket and a lock body includes an opening in the bracket configured to receive the lock body, and a swing support attached to the bracket. The swing support may be movable between a closed position and an open position, and the swing support may be configured such that the lock body is free to be inserted or removed from the opening when the swing support is in the open position and the swing support prevents the lock body from being inserted or removed from the opening when the swing support is in the closed position. The combination may further include on of an indent or protrusion disposed on the swing support and the other of the indent or protrusion disposed on a surface of the lock body, wherein the other of the indent or protrusion id complementary to the indent or protrusion disposed on the swing support such that the indent or protrusion disposed on the swing support registers with the other of the indent or protrusion disposed on the lock body when the swing support is in the closed position.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a perspective view of a secure storage box according to one illustrative embodiment;

FIG. 2 is a perspective view of a locking system of a secure storage box according to one illustrative embodiment;

FIG. 3 is a perspective view of a lock post bracket of a secure storage box according to one illustrative embodiment;

FIG. 4 is a perspective view of a lock body bracket of a secure storage box according to one illustrative embodiment;

FIG. 5 is a perspective view of the lock body bracket of FIG. 4 with a lock body installed within the lock body bracket according to one illustrative embodiment;

FIG. 6 is a cross sectional view of the lock body bracket of FIG. 5 with a lock body installed within the lock body bracket along line 6-6 according to one illustrative embodiment;

FIG. 7A-7C show a lock body being installed into a lock body bracket of a secure storage box according to one illustrative embodiment;

FIG. 8A is a lock body of a secure storage box according to one embodiment;

FIG. 8B is a swing support of a secure storage box complementary to the lock of FIG. 8A according to one illustrative embodiment; and

FIG. 9 is a lock body bracket of a secure storage box holding a lock body drawn in phantom according to one illustrative embodiment.

### DETAILED DESCRIPTION

Conventionally, an intended recipient of a parcel may choose to employ methods for preventing or deterring the theft of the parcel when the parcel is left (e.g., by a delivery carrier) at the residence of the intended recipient. For example, an intended recipient may install cameras, signs, or gates at the residence to dissuade a thief from stealing a parcel left at the residence. However, while some of these systems may assist in parcel recovery (e.g., a camera system), such systems may not directly prevent a thief from stealing a parcel left at the residence. Thus, to prevent the theft of a parcel, an intended recipient of the parcel may wish to install a secure storage box at the residence. The secure storage box may be constructed to be accessible only to the delivery carrier and the intended recipient of a parcel. Thus, the secure storage box may allow a delivery carrier to drop off a parcel securely within the box, allowing the intended recipient to retrieve the parcel at his or her convenience.

Additionally, to confirm delivery of a parcel, a sender of the parcel may require that an intended recipient of the parcel be personally present to receive the parcel (e.g., to provide a signature). A secure storage box may additionally allow a delivery carrier to confirm delivery of a parcel to the secure storage box, thus allowing the delivery carrier to complete delivery of the parcel without requiring the intended recipient to be physically present during delivery. To facilitate such functionality, the secure storage box may be equipped with a locking system constructed to allow only the delivery carrier and the intended recipient to access the contents of the secure storage box. For example, the secure storage box may include an electronic lock equipped with a processor capable of interfacing with a phone application allowing only authorized individuals (e.g., the delivery carrier and the intended recipient) to access the secure storage box. Thus, it may be desirable for the secure storage box to be equipped with a suitable electronic lock body capable of interfacing with a particular phone application. The electronic lock body may be mounted within a bracket disposed within the secure storage box such that the electronic lock may function as intended. However, installing an alternative electronic lock body within the secure storage box may introduce security vulnerabilities or compatibility issues with the phone of the delivery carrier and/or the intended recipient.

In view of the above, the Inventors have recognized the advantages of a secure storage box that includes a mounting system constructed to accommodate an appropriate lock body, such as an electronic lock body (e.g., receive only a compatible electronic lock body). For example, in some embodiments, a secure storage box may include a bracket for receiving a lock body. The bracket may be constructed to hold the lock body within a receiving region (also referred to as an opening) of the bracket. In some instances, the bracket includes a T-slot. An appropriate lock body (e.g., an electronic lock body as described above), may include a T-fastener complementary to the T-slot such that the T-fastener may slide into the T-slot (e.g., via a lip mated to the geometry of the T-slot). Thus, the T-slot may prevent the T-fastener from moving in at least a first direction, and by extension, the T-slot may prevent the lock body to which the T-fastener is attached from moving in at least the first direction. The first direction is the direction perpendicular to the sliding movement of inserting the T-fastener in the T-slot. Moreover, the bracket may include a retaining tab for retaining the T-fastener within the T-slot. In embodiments including a retaining tab, a user may first need to apply a force to the retaining tab to displace the retaining tab away from the T-slot, allowing the user to fit the T-fastener into the T-slot. Once the user fits the T-fastener into the T-slot, the user may then release the tab, which may block the T-fastener from being removed from the T-slot. Thus, when the T-fastener is inserted into the T-slot, the tab may prevent the T-fastener, and by extension the lock body to which the T-fastener is attached, from moving in a second direction (i.e., sliding back out of the T-slot). In some instances, the second direction may be a direction of gravity. In some instances, the T-slot may be employ a stop on one side, thus preventing the T-fastener and the lock body to which the T-fastener is attached from moving beyond the stop in a direction of the seal (e.g., a third direction). In some embodiments, the direction of the seal is opposite to the direction of gravity.

The bracket may also include a swing support to further hold the lock body within the receiving region. For example, once a user places the lock body into the opening in the bracket, the swing support may serve to retain the lock body within the bracket. The swing support holding the lock body within the receiving region may be in addition to or instead of the above-mentioned retaining tab. The swing support may be capable of moving between an open position and a closed position. In the open position, the lock body may unimpeded by the swing support. In embodiments employing the retaining tab, the lock body may be held in place by the retaining tab even when the swing support is in the open position. In the locked position, the swing support may prevent the lock body from moving out of the retaining region.

The swing support and the lock body may include complementary features that allow a particular lock body to be inserted into the retaining region while preventing other lock bodies from being inserted therein. Thus, in one embodiment, the swing support may include features allowing the swing support to register with a lock body. For example, the swing support may include a protrusion or an indent, while the lock body may include the other of the protrusion or the indent. Moreover, the protrusion and the indent may be configured to register with one another. For example, in some instances, the swing support may include an indent while the lock body includes a protrusion. In such instances, the indent on the swing support may be complementary to a protrusion on the lock body. Thus, the indent on the swing support may register with (e.g., surround) the protrusion on the lock body and engage with the geometry of the protrusion on the lock body when the swing support is in the closed position. Relatedly, the indent on the swing support may not be complementary with a lock body incompatible with the secure storage box, preventing a user from installing the incompatible lock body or otherwise alerting the user to the incompatibility of the lock body.

Conversely, in some instances, the swing support may include a protrusion while the lock body includes an indent complementary to the protrusion disposed on the swing support. In such instances, the protrusion on the swing support may register with the indent in the lock body when the swing support is in the closed position. Relatedly, the protrusion on the swing support may prevent the swing support from transitioning to the closed position when a lock body without a complementary indent (e.g., an incompatible lock body) is inserted into the bracket. Thus, the bracket may include features to prevent a user from installing an incompatible lock body into the mounting bracket of a secure storage box.

When the lock body is inserted into the retaining region of the bracket, the lock body is prevented from further upward movement by the stops in the T-slot, as explained above. Alternatively, or in addition, the storage box itself may include a ledge formed on the outer peripheral lip such that the lock body is further prevented from moving out of the retaining region. Moreover, the ledge may serve to incentivize a user to install an appropriate lock body (e.g., a lock body fit for the purpose of securing the secure storage box), as the geometry of the ledge may conform to the geometry of an appropriate lock body or a series of appropriate lock bodies. Additionally, the ledge may be constructed to cover a portion of the lock body such that the opening in the lock body for receiving the lock post remains exposed.

Additionally, in some instances, the lock body may be configured to selectively retain a lock post within an opening in the lock body. For example, the secure storage box may have a lock post disposed on a lid of the secure storage box, while the lock body may be mounted to a bracket (e.g., as described above) on a wall of a body of the secure storage box. The lock post may be positioned on the lid of the secure storage box such that the lock post aligns with the opening in the lock body. Thus, when the lock body retains the lock post, the lid of the secure storage box is prevented from opening. However, during shipping or after extended use of a secure storage box, the lock post bracket and the lock body bracket may come lose and/or move out of position.

In view of the above, the Inventors have recognized the advantages of a secure storage box equipped with features that allow the lock post to align with the opening in the lock body. For example, in some embodiments, the secure storage box includes a lock post bracket (e.g., a bracket constructed to retain the lock post) and lock body bracket (e.g., a bracket constructed to retain the lock body as described above) capable of aligning with one another. To that end, each the lock post bracket and the lock body bracket may include structures constructed to register with one another to confirm that the lock post is appropriately aligned with the opening in the lock body.

Specifically, in some instances, the lock post bracket may include a pair of hollow cylinders constructed to register with a pair of pins disposed on the lock body bracket. When the lock body and lock post are appropriately aligned, the hollow cylinders of the lock post bracket may fit over the pins of the lock body bracket when the lid of the secure storage box is closed. Relatedly, if the lock post and lock body are out of alignment, the hollow cylinders disposed on the lock post bracket may not fit over the pins disposed on the lock body bracket, alerting the user that the lock post and lock body are out of alignment. Accordingly, the user may then repair the lock post and/or lock body as needed. In other instances, the lock post bracket includes a pair of pins configured to register with a pair of hollow cylinders disposed on the lock body bracket similarly to the above. Moreover, the lock post bracket and the lock body bracket may each include one pin and one hollow cylinder each in a configuration such that each pin registers with a hollow cylinder. Of course, embodiments with one, three or greater than three pins and/or hollow cylinders are also contemplated.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

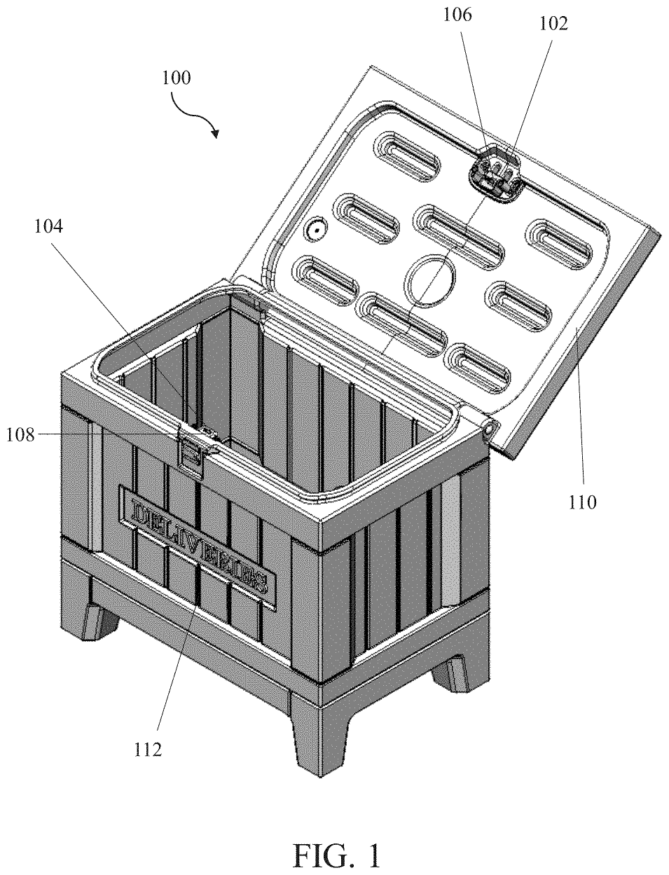

FIG. 1 is a perspective view of a secure storage box 100 according to an illustrative embodiment. Storage box 100 may include a lock post bracket 102 and a lock body bracket 104. A lock post 106 may be mounted to lock post bracket 102 and a lock body 108 may be mounted to lock body bracket 106. In turn, lock post bracket 102 may be mounted to a lid 110 of the storage box 100 while lock body bracket 104 may be mounted to a body portion 112 of storage box 100. Lock post bracket 102 and lock body bracket 104 may be positioned such that when lid 110 is closed over body portion 112, lock post 106 interfaces with lock body 108. Lock body 108 may be capable of selectively retaining lock post 106 such that when lock post 106 is retained within lock body 108, lid 110 remains fixed to body portion 112, preventing access to the contents of secure storage box 100.

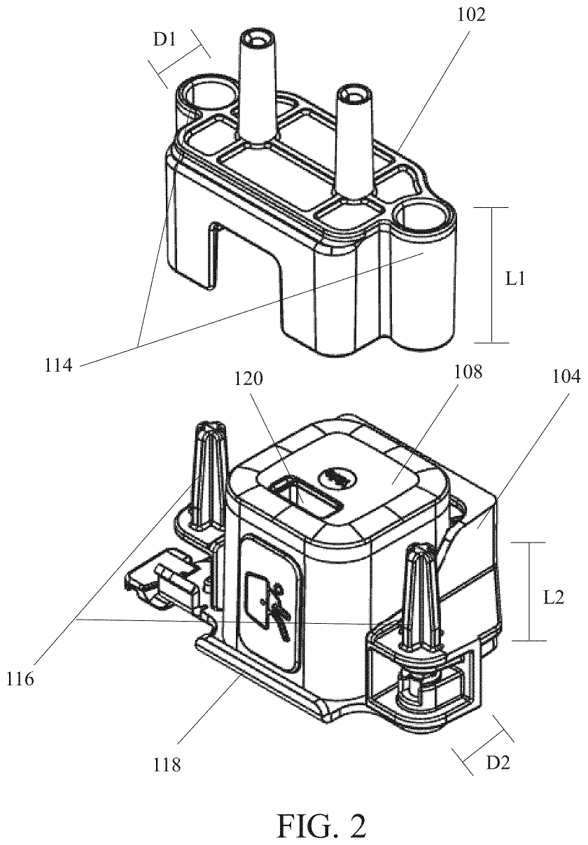

As shown in FIG. 2, lock post bracket 102 and lock body bracket 104 may include a pair of hollow cylinders 114 and a pair of pins 116 respectively for confirming the alignment of lock post 106 with lock body 108. For example, hollow cylinders 114 may be positioned such that hollow cylinders 114 fit over or otherwise register with pins 116 when lock post 106 aligns with an opening 120 in lock body 108 (e.g., lock post 106 fits into opening 120 such that a mechanism within lock body 108 may retain lock post 106). Specifically, hollow cylinders 114 may have an inner diameter D1 and pins 116 may have a maximum diameter D2. Thus, hollow cylinders 114 may be able to fit over pins 116. In some instances, inner diameter D1 may be only slightly smaller than the maximum diameter D2, restricting a margin of error for misalignment between lock post 106 and opening 120. However, the relative values of inner diameter D1 relative to maximum diameter D2 may be tuned for any suitable purpose. For example, without wishing to be bound by theory, the ratio of inner diameter D1 to maximum diameter D2 (i.e., D1/D2) may be increased to increase the margin of error of misalignment between lock post 106 and opening 120. Relatedly, the ratio of inner diameter D1 to maximum diameter D2 may be decreased to limit the margin of error of misalignment between lock post 106 and opening 120.

Lock post bracket 102 and lock body bracket 104 may be constructed and arranged to have an inner diameter D1 and/or a maximum diameter D2 of any suitable value. For example, in various embodiments, inner diameter D1 and/or a maximum diameter D2 may be 9 mm or at least 9 mm, 10 mm or at least 10 mm, 11 mm or at least 11 mm, or any other suitable value. Further, in various embodiments, inner diameter D1 and/or a maximum diameter D2 may be less than 14 mm, less than 13 mm, less than 12 mm, or any other suitable value. Combinations of the above referenced ranges are also contemplated. For example, inner diameter D1 and/or a maximum diameter D2 may be between 9 mm and 14 mm inclusive, between 10 mm and 13 mm inclusive, or between 10 mm and 11 mm inclusive. Inner diameter D1 and/or a maximum diameter D2 may take on other suitable values or ranges, depending on the application.

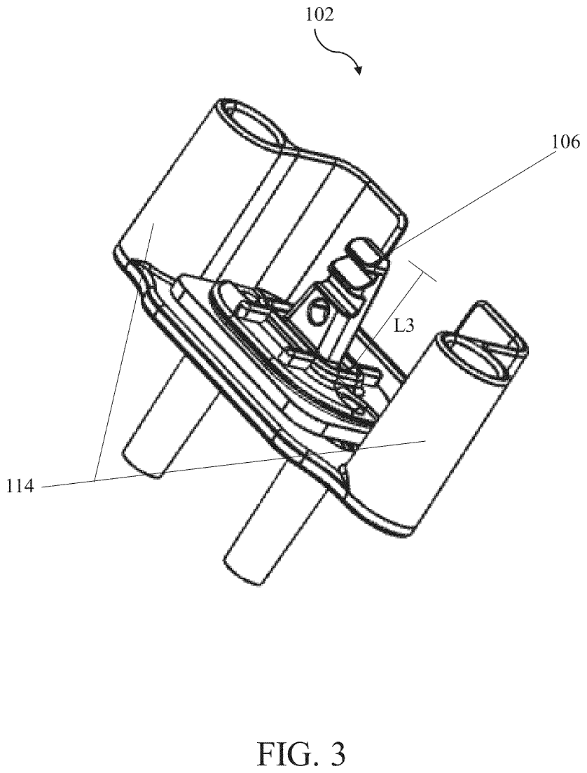

Moreover, hollow cylinders 114 may be constructed to fit over a length of pins 116. For example, hollow cylinders 114 may be constructed with a first length L1 and pins 116 may be constructed with a second length L2. Without wishing to be bound by theory, the ratio of first length L1 to second length L2 (i.e., L1/L2) may influence the distance that lock post 106 may travel into opening 120. For example, lock post bracket 102 and lock body bracket 104 may be constructed such that when the ratio of first length L1 to second length L2 is approximately 1 (i.e., first length L1 is approximately equal to second length L2), the full length L3 (as shown in FIG. 3) of lock post 106 is disposed within opening 120 when lock post bracket 102 is fit over lock body bracket 104. Of course, lock post bracket 102 and lock body bracket 104 may be constructed with a ratio of first length L1 to second length L2 of greater then 1, for example in applications where only a portion of the full length L3 of lock post 106 is meant to fit within opening 120. Lock post bracket 102 and lock body bracket 104 may be constructed and arranged to have a first length L1 and/or a second length L2 of any suitable value. For example, in various embodiments, first length L1 and/or second length L2 may be 27 mm or at least 27 mm, 28 mm or at least 28 mm, 29 mm or at least 29 mm, or any other suitable value. Further, in various embodiments, first length L1 and/or second length L2 may be less than 32 mm, less than 31 mm, less than 30 mm, or any other suitable value. Combinations of the above referenced ranges are also contemplated. For example, first length L1 and/or second length L2 may be between 27 mm and 32 mm inclusive, between 28 mm and 31 mm inclusive, or between 29 mm and 30 mm inclusive. First length L1 and/or second length L2 may take on other suitable values or ranges, depending on the application.

Further, lock post 106 may be constructed and arranged to have a full length L3 of any suitable value. For example, in various embodiments, full length L3 may be 17 mm or at least 17 mm, 18 mm or at least 18 mm, 19 mm or at least 19 mm, or any other suitable value. Further, in various embodiments, full length L3 may be less than 22 mm, less than 21 mm, less than 20 mm, or any other suitable value. Combinations of the above referenced ranges are also contemplated. For example, full length L3 may be between 17 mm and 22 mm inclusive, between 18 mm and 21 mm inclusive, or between 19 mm and 20 mm inclusive. Full length L3 may take on other suitable values or ranges, depending on the application.

Of course, alternatives to the embodiments shown in FIGS. 1-3 are also contemplated. For example, in some instances, the lock body bracket may include a pair of hollow cylinders while the lock post bracket may include a pair of hollow cylinders (e.g., constructed to register with one another as described above). Additionally, the lock post bracket may include one hollow cylinder and one pin, while the lock body bracket includes one complementary hollow cylinder and one complementary pin. Of course, the lock post bracket and the lock body bracket need not include cylinders or pins as other suitable members of different shapes are also contemplated.

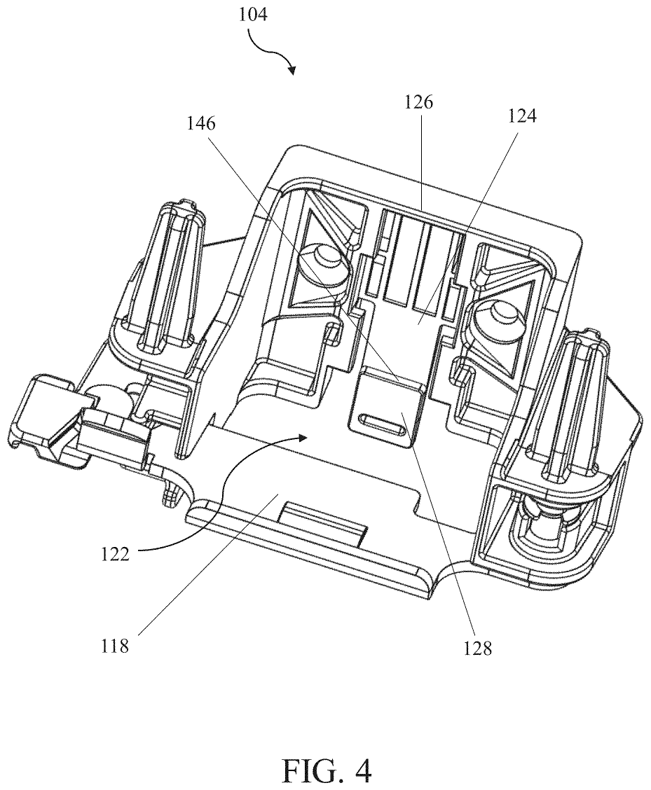

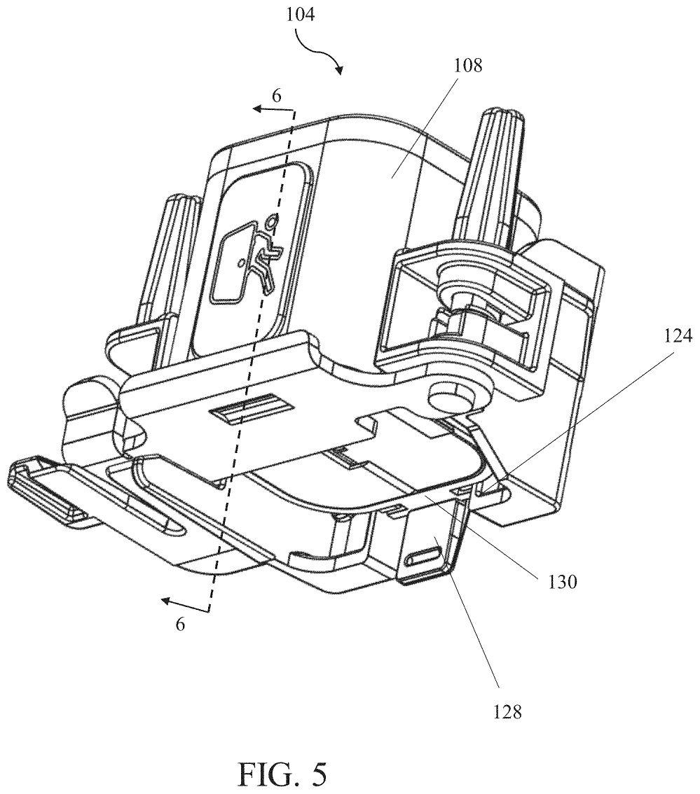

Additionally, as shown in FIG. 4 (among other FIGS.), lock body bracket 104 may include features for retaining lock body 108 within lock body bracket 104. For example, lock body bracket 104 may include an opening 122 where lock body 108 may reside. Lock body 108 may be attached to lock body bracket 104 via a T-slot 124. The-T-slot may have a stop 126 on a first and a tab 128 on a second end. Stop 126 may be fixed, while tab 128 may be movable (e.g., by hand) to allow a corresponding feature on lock body 108 to interface with T-slot 124. Specifically, tab 128 may be movable between a closed position (e.g., for retaining lock body 108 within T-slot 124) and an open position (e.g., for allowing a user to install lock body 108 within T-slot 124). Further, tab 128 may have a bias towards the closed position. Thus, in some instances, the user may apply a force to tab 128 to move tab 128 away from the closed position to install lock body 108 and may then release tab 128, which may subsequently move back to the closed position via the bias discussed above, retaining lock body 128 (e.g., as shown in FIG. 5).

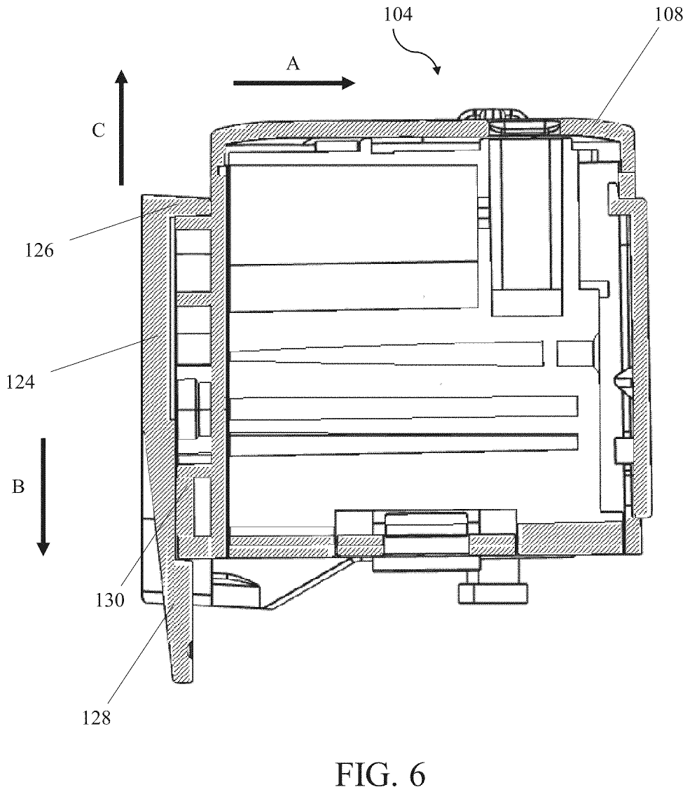

Lock body 108 may include a T-fastener 130 complementary to T-slot 124. T-fastener 130 may fit within T-slot 124. In turn, T-fastener 130 may be formed with or attached to lock body 108, such that when T-slot 124 retains T-fastener 130, T-slot 124 prevents lock body 128 from moving in one or more directions. For example, the interface between T-fastener 130 and T-slot 124 may prevent lock body 108 moving in a first direction A, as shown in FIG. 6. Relatedly, tab 128 may restrain lock body 108, preventing lock body 108 from moving in a second direction B, perpendicular to first direction A. In some embodiments, second direction B is a direction of gravity. Thus, tab 128 may prevent lock body 128 from moving within secure storage box 100 under the weight of lock body 108. Specifically, tab 128 may include a ledge 146. Ledge 146 may move as tab 128 moves. Thus, as tab 128 is moved to the open position, ledge 146 does not block T-slot 124, allowing lock body 108 to be inserted or removed from T-slot 124. Relatedly, when tab 128 is moved to the closed position, ledge 146 may prevent lock body 108 from being installed or moving out of T-slot 124 in a direction of lodge 146 (e.g., second direction B). Moreover, seal 126 may prevent lock body from moving in a third direction C, opposite second direction B (e.g., opposite to the direction of gravity) and perpendicular to first direction A. Accordingly, T-slot 124 may serve to restrict the movement of lock body 108 via T-fastener 130.

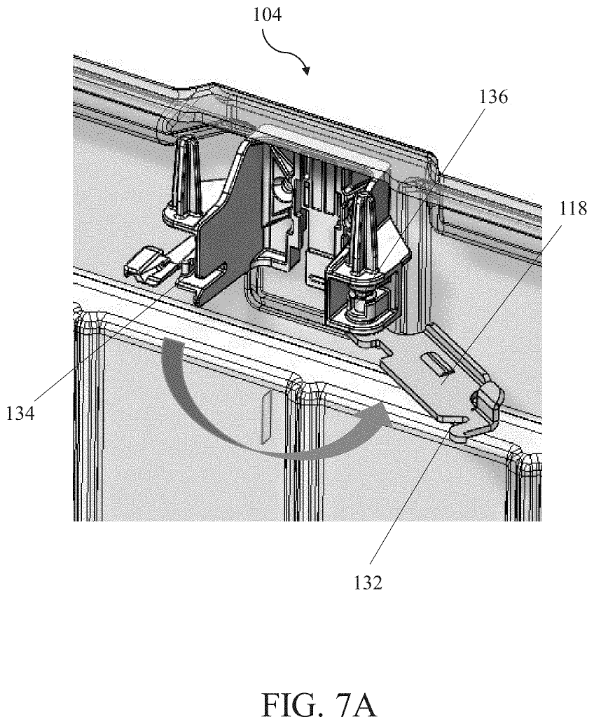

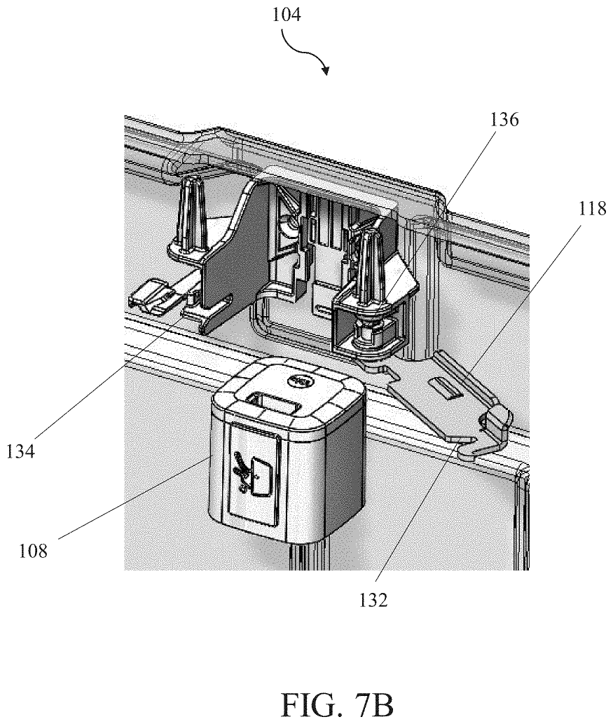

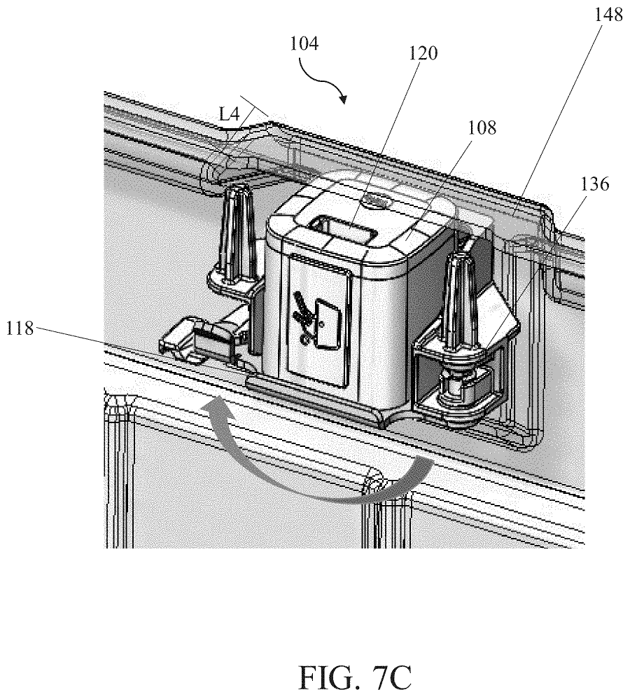

In some instances, lock body bracket 104 may also include a swing support 118 constructed to retain lock body 108 within opening 122. Particularly, swing support 118 may serve to bolster the support of T-slot 124, as shown in FIGS. 7A-7C. Particularly, a user may install lock body 108 into lock body bracket 104 by first opening swing support 118 and pushing tab 128 into the open position as described above. Then, the user may slide T-fastener 130 into T-slot 124 and release tab 128, as described above. The user may then close swing support 118. In some embodiments, swing support 118 includes features for transitioning swing support 118 from an open state to a closed state to facilitate the installation of lock body 108, for example by using the method described above. Swing support 118 may be rotatably fixed to lock body bracket 104 via a pivot pin 136. Thus, swing support 118 may rotate about a fixed point at pivot pin 136. Moreover, swing support 118 may include a compliant female contact 132, while lock body bracket 104 may include a male blade 134. Compliant female contact 132 may be constructed to fit over male blade 134 such that compliant female contact 132 press fits into male blade 134, fixing swing support 118 in the closed position. When female contact 132 press fits into male blade 134, an audible “snap” or other suitable sound may be heard, alerting the user that swing support 118 is fixed in the closed position. In the closed position, swing support 118 may prevent lock body 108 from moving in first direction A and/or second direction B.

Moreover, as shown in FIG. 7C, secure storage box 100 may include a ledge 148 disposed on or formed with an outer lip of secure storage box 100. Ledge 148 may serve to prevent the lock body from moving in a direction of the ledge (e.g., direction C) in addition to the other features of lock body bracket 104. Ledge 148 may extend a fourth length L4 along a surface of lock body 108 such that opening 120 remains accessible to lock post 106. The shape of ledge 148 may serve to ensure that lock body 108 is a lock body of appropriate type. For example, in some instances, an inappropriate lock body may fail to fit within lock body bracket 104 when the inappropriate lock body includes geometry that conflicts with ledge 148.

In some instances, lock body bracket 104 may include an interface for confirming whether a given lock body installed within lock body bracket 104 is an appropriate lock body. For example, lock body bracket 104 may include a bracket interface, and lock body 108 may include a lock body interface. The lock body interface may be complementary to the bracket interface such that the lock body interface registers (e.g., nests) with the bracket interface when lock body 108 is positioned (e.g., installed) in lock body bracket 104. Further, the bracket interface may serve to prevent an inappropriate lock body from being installed into lock body bracket 104. Alternatively, or in addition, the bracket interface may also alert the user to the face that a given lock body is an inappropriate lock body when relevant.

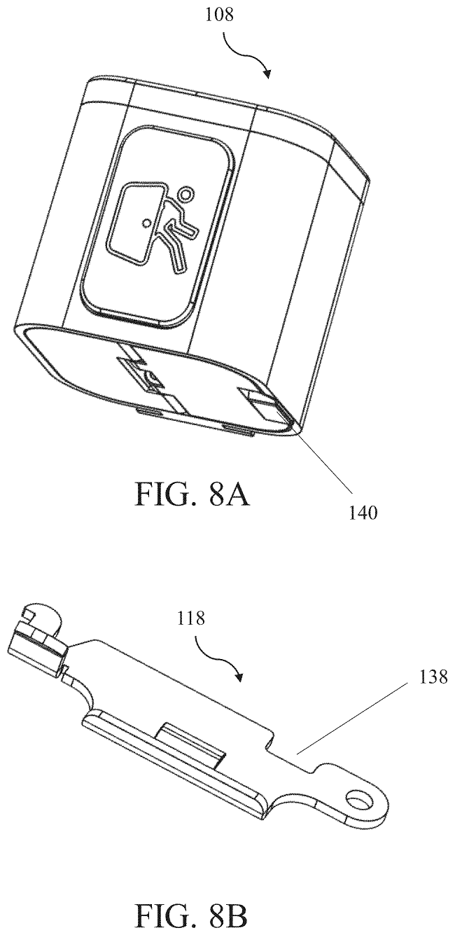

For example, swing support 118 may include features allowing swing support 118 to register with lock body 108 to confirm that lock body 108 is a lock body of appropriate type. For example, as shown in FIGS. 8A-8B, swing support 118 may include an indent 138 constructed to register with a protrusion 140 disposed on lock body 108. For example, an appropriate lock body 108 may include a protrusion sized to fit within indent 138 to denote that lock body 108 is compatible with a lock body bracket 104, which includes swing support 118 with indent 138. Relatedly, an inappropriate lock body may include a protrusion having a geometry incompatible with indent 138 such that swing support 118 may not be able to close over the protrusion of the inappropriate lock body. Thus, in such a situation, a user may be alerted to the fact that the lock body within lock body bracket 104 is an inappropriate lock body, which may not be fit for the purpose of securing secure storage box 100. Accordingly, the user may then procure and install an appropriate lock body.

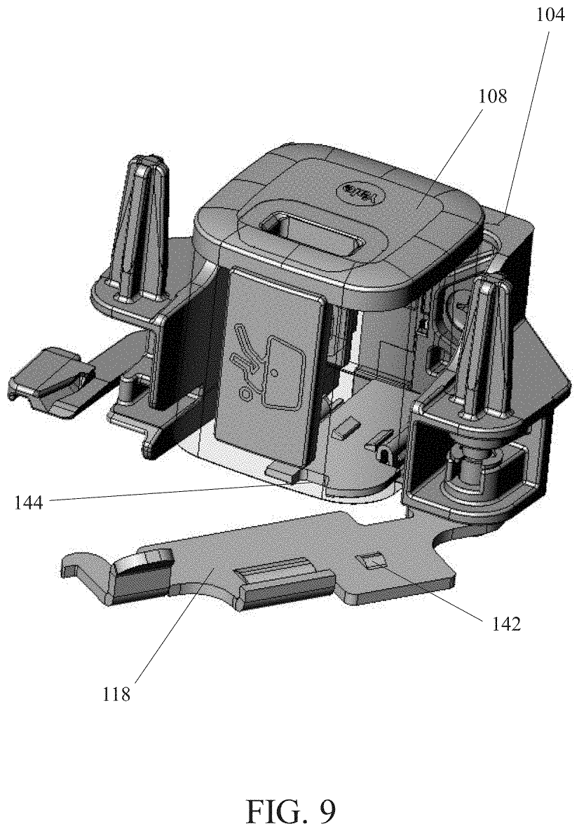

Though in some embodiments, lock body 108 includes protrusion 140 that registers with indent 138 as described above, this need not be the case, as shown in FIG. 9. For example, swing support may alternatively include a protrusion 142, while lock body 108 includes an indent 144. Indent 144 may be complementary to protrusion 142 such that protrusion 142 registers with indent 144 when swing support 118 is in the closed position. Relatedly, when an inappropriate lock body is installed in lock body bracket 104, swing support 118 may be prevented from moving into the closed position. For example, protrusion 142 may come into contact with a surface of the inappropriate lock body, preventing the swing stop from reaching the closed position. Accordingly, a user may be alerted to the fact that the lock body within lock body bracket 104 is an inappropriate lock body, which may not be fit for the purpose of securing secure storage box 100. Accordingly, the user may then procure and install an appropriate lock body. Of course, embodiments with a protrusion and indent on both swing support 118 and lock body 108 are also contemplated.

Alternatively, swing support 118 may include other features configured to register with one or more complementary features on lock body 108 to confirm that lock body 108 is an appropriate lock body for securing secure storage box 100. For example, swing support 118 may include one or more walls constructed to conform to one or more surfaces or edges of lock body 108. Additionally, in some embodiments, an appropriate lock body may include one or more slots for receiving swing support 118, wherein the slot is complementary to the shape of swing support 118. Of course, lock body 108 and/or swing support 118 may include other features for confirming that lock body 108 is an appropriate lock body for securing secure storage box 100, depending on the application.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A lock for a secure storage box, the secure storage box having a bracket configured to receive the lock and having a bracket interface, the lock comprising:
a lock body; and
a lock body interface complementary to bracket interface whereby lock body interface registers in a nesting relationship with the bracket interface when the lock body is positioned in the bracket such that a lock body lacking the corresponding lock body interface is incapable of registering in the nesting relationship with the bracket.

2. The lock of claim 1, in combination with the bracket, wherein the bracket further comprises a swing support attached to the bracket, wherein the swing support is movable between a closed position and an open position, wherein the swing support is configured such that the lock body is free to be inserted or removed from the opening when the swing support is in the open position and the swing support prevents the lock body from being inserted or removed from the opening when the swing support is in the closed position, wherein the swing support includes the bracket interface.

3. The lock of claim 2, wherein the swing support includes the indent and the lock body includes the protrusion.

4. The lock of claim 2, wherein the swing support prevents the lock body from moving in at least a first direction.

5. The lock of claim 4, wherein the swing support prevents the lock body from moving in a second direction.

6. The lock of claim 5, wherein the second direction is perpendicular to the first direction.

7. The lock of claim 6, wherein the second direction is a direction of gravity.

8. A secure storage box comprising:
a post bracket;
a lock body bracket;
two or more alignment pins disposed on the lock body bracket;
two or more hollow cylinders disposed on the post bracket; and
wherein the two or more alignment pins and the two or more hollow cylinders are positioned such that the two or more hollow cylinders fit over the two or more alignment pins.

9. The secure storage box of claim 8, wherein a length of the hollow cylinders equals a length of the alignment pins.

10. The secure storage box of claim 8, wherein the post bracket is fixed to a moveable lid of the storage box.

11. The secure storage box of claim 8 in combination with a lock body, wherein the lock body bracket is configured to retain the lock body.

12. The secure storage box of claim 8, wherein the lock body bracket is fixed to an interior wall of the storage box.

13. The secure storage box of claim 12 in combination with a lock post disposed on the post bracket.

14. The secure storage box of claim 13, wherein the lock body has an opening configured to accept the lock post.

15. The secure storage box of claim 14, wherein the two or more alignment pins and the two or more hollow cylinders are positioned such that the two or more hollow cylinders fit over the two or more alignment pins when the lock post fits over the opening.

16. The secure storage box of claim 15, wherein the lock body bracket includes a T-slot configured to retain the lock body within the bracket via a complementary T-fastener disposed on the lock body.

17. The secure storage box of claim 16, wherein the lock body bracket includes a swing support.

18. The secure storage box of claim 17, wherein the swing support is configured to transition between an open position and a closed position, wherein the swing support retains the lock body within the lock body bracket in the closed position.

19. The secure storage box of claim 18, wherein the swing support includes a protrusion configured to register with an indent complementary to the protrusion disposed on a surface of the lock body such that the protrusion registers with the indent when the swing support is in the closed position.

20. The secure storage box of claim 8, wherein an inner diameter of the two or more hollow cylinders is approximately equal to a maximum diameter of the two or more alignment pins.

21. A bracket for receiving a lock body comprising:
an opening configured to receive the lock body;
a T-slot configured to retain the lock body within the opening;
wherein the lock body includes a T-fastener complementary to the T-slot;
wherein the T-slot is configured prevent the lock body from moving in at least a first direction when the T-fastener is inserted into the T-slot.

22. The bracket of claim 21, further including a swing support configured to retain the lock body within the bracket.

23. The bracket of claim 22, wherein the swing support is configured to transition between an open position and a closed position, wherein the swing support retains the lock body within the lock body bracket in the closed position.

24. The bracket of claim 23, wherein the swing support includes a protrusion configured to register with an indent complementary to the protrusion disposed on a surface of the lock body such that the protrusion registers with the indent when the swing support is in the closed position.

25. The bracket of claim 21, further including a tab configured to prevent the lock body from moving in at least a second direction when the lock body is inserted into the opening.

26. The bracket of claim 25, wherein the second direction is perpendicular to the first direction.

27. The bracket of claim 26, wherein the second direction is a direction of gravity.

28. The bracket of claim 21, wherein the T-slot is configured prevent the lock body from moving in a third direction when the T-fastener is inserted into the T-slot.

29. The bracket of claim 28, wherein the third direction is perpendicular to the first direction.

30. The bracket of claim 29, wherein the third direction is opposite to a direction of gravity.
